(19) United States
(12) Patent Application Publication
(10) Pub. No.: US 2014/0188949 A1
(43) Pub. Date: Jul. 3, 2014

(54) METHODS AND SYSTEMS FOR SUPPLY CHAIN ASSURANCE OF INFORMATION HANDLING SYSTEM CODE

(71) Applicant: DELL PRODUCTS L.P., Round Rock, TX (US)

(72) Inventors: Ricardo L. Martinez, Leander, TX (US); James Randall Romike, Cedar Park, TX (US)

(73) Assignee: DELL PRODUCTS L.P., Round Rock, TX (US)

(21) Appl. No.: 13/733,584

(22) Filed: Jan. 3, 2013

(51) Int. Cl. G06F 17/30

(52) U.S. Cl. CPC G06F 17/30097
USPC 707/821

(57) ABSTRACT

In accordance with embodiments of the present disclosure, an information handling system may include a processor and a program of instructions embodied in a computer-readable medium. The instructions may be configured to, when read and executed by the processor: (i) store in an image map file one or more range descriptors recording one or more physical memory address ranges storing code to be installed to a second information handling system; and (ii) store in the image map file one or more hashes, each hash associated with code stored in a respective one of the one or more physical memory address ranges.

### TECHNICAL FIELD

The present disclosure relates in general to information handling systems, and more particularly to information assurance and supply chain security in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A key component of almost every information handling system is the basic input/output system (BIOS). A BIOS may be a system, device, or apparatus configured to identify, test, and/or initialize one or more information handling resources of an information handling system, typically during boot up or power on of an information handling system. A BIOS may include boot firmware configured to be the first code executed by a processor of an information handling system when the information handling system is booted and/or powered on. As part of its initialization functionality, BIOS code may be configured to set components of the information handling system into a known state, so that one or more applications (e.g., an operating system or other application programs) stored on compatible media may be executed by a processor and given control of the information handling system and its various components.

Because of the importance of a BIOS in the overall execution of an information handling system, many customers of information handling systems demand that vendors of information handling systems assure that information handling systems and the code stored thereon, including the BIOS, be free of malicious code upon delivery, not be subject to introduction of malicious code in the supply chain of individual information handling systems, and not be altered in the supply chain.

### SUMMARY

In accordance with the teachings of the present disclosure, the disadvantages and problems associated with supply chain assurance in an information handling system have been reduced or eliminated.

In accordance with embodiments of the present disclosure, an information handling system may include a processor and a program of instructions embodied in a computer-readable medium. The instructions may be configured to, when read and executed by the processor: (i) store in an image map file one or more range descriptors recording one or more physical memory address ranges storing code to be installed to a second information handling system; and (ii) store in the image map file one or more hashes, each hash associated with code stored in a respective one of the one or more physical memory address ranges.

In accordance with these and other embodiments of the present disclosure, an information handling system may include a processor and a program of instructions embodied in a computer-readable medium. The instructions may be configured to, when read and executed by the processor: (i) store in a first image map file one or more range descriptors recording one or more physical memory address ranges of a first memory storing code; (ii) store in the first image map file one or more hashes, each hash associated with code stored in a respective one of the one or more physical memory address ranges of the first memory; (iii) receive a second image map file, the second image map file created by storing in the second image map file one or more range descriptors recording one or more physical memory address ranges of a second memory storing code, and storing in the second image map file one or more hashes, each hash associated with code stored in a respective one of the one or more physical memory address ranges of the second memory; and (iv) compare the first image map file to the second image map file.

In accordance with these and other embodiments of the present disclosure, a method may include storing in an image map file one or more range descriptors recording one or more physical memory address ranges storing code to be installed to a second information handling system, and storing in the image map file one or more hashes, each hash associated with code stored in a respective one of the one or more physical memory address ranges.

In accordance with these and other embodiments of the present disclosure, a method may include storing in a first image map file one or more range descriptors recording one or more physical memory address ranges of a first memory storing code. The method may also include storing in the first image map file one or more hashes, each hash associated with code stored in a respective one of the one or more physical memory address ranges of the first memory. The method may additionally include receiving a second image map file, the second image map file created by storing in the second image map file one or more range descriptors recording one or more physical memory address ranges of a second memory storing code, and storing in the second image map file one or more hashes, each hash associated with code stored in a respective one of the one or more physical memory address ranges of the second memory. The method may further include comparing the first image map file to the second image map file.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates an example flow diagram of an example method for building and releasing a BIOS, in accordance with embodiments of the present disclosure; and

FIG. 3 illustrates an example flow diagram of an example method for verifying a BIOS, in accordance with embodiments of the present disclosure.

### DETAILED DESCRIPTION

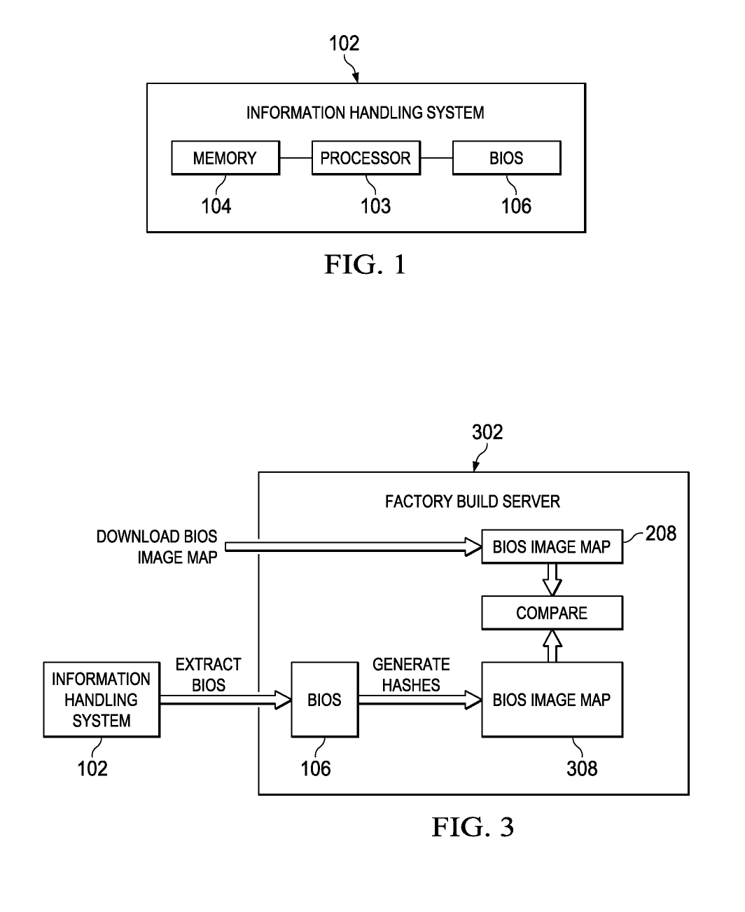

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, BIOSs, busses, memories, I/O devices and/or interfaces, storage resources, network interfaces, motherboards, and/or any other components and/or elements of an information handling system.

FIG. 1 illustrates a block diagram of an example information handling system 102, in accordance with certain embodiments of the present disclosure. In certain embodiments, information handling system 102 may be a server. In another embodiment, information handling system 102 may be a personal computer (e.g., a desktop computer or a portable computer). As depicted in FIG. 1, information handling system 102 may include a processor 103, a memory 104 communicatively coupled to processor 103, and a BIOS 106 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 106 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 106 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 106 may be implemented as a program of instructions that may be read by and executed on processor 103 to carry out the functionality of BIOS 106. In these and other embodiments, BIOS 106 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

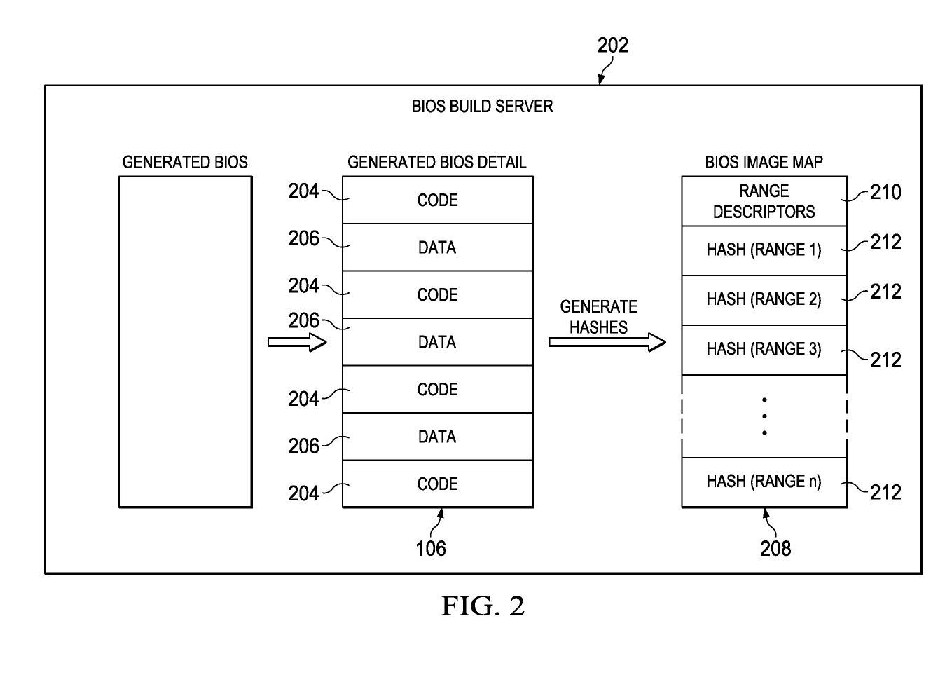

FIG. 2 illustrates an example flow diagram of an example method for building and releasing a BIOS 106, in accordance with embodiments of the present disclosure. As depicted in FIG. 2, the method depicted in FIG. 2 may be performed by a BIOS build server 202. In some embodiments, BIOS build server 202 may be an information handling system. In these embodiments, BIOS build server 202 may be similar in structure and/or function as information handling system 102 depicted in FIG. 1. The functionality of BIOS build server 202 may be implemented by a program of instructions embodied on a computer-readable medium integral to or associated with BIOS build server 202 (e.g., a memory) and executable by a processor integral to BIOS build server 202.

As shown in FIG. 2, as is typical in the art, after BIOS code is developed or “generated”, individual portions of BIOS code 204 and data 206 associated with BIOS code may be stored in a number of memory ranges of the computer-readable media making up BIOS 106. In accordance with embodiments of the present disclosure, BIOS build server 202 may generate a BIOS image map file 208. Within BIOS image map file 208, BIOS build server 202 may store range descriptors 210 which record the physical memory address ranges of BIOS code 204 (e.g., the various individual portions of BIOS code 204) as it is written to the memory. In addition, within BIOS image map file 208, BIOS build server 202 may generate hashes 212 of the BIOS code stored in each of the physical memory ranges of the BIOS code. Such hashes may be generated using any suitable method for creating a hash (e.g., secure hash algorithm-256 or “SHA-256”). The BIOS image map 208 may be released with the signed BIOS 106 for use on an information handling system.

FIG. 3 illustrates an example flow diagram of an example method for verifying a BIOS 106, in accordance with embodiments of the present disclosure. As depicted in

FIG. 3, the method depicted in FIG. 3 may be performed by a factory build server 302. In some embodiments, factory build server 302 may be an information handling system. In these embodiments, factory build server 302 may be similar in structure and/or function as information handling system 102 depicted in FIG. 1. The functionality of factory build server 302 may be implemented by a program of instructions embodied on a computer-readable medium integral to or associated with factory build server 302 (e.g., a memory) and executable by a processor integral to factory build server 302. In general, factory build server 302 may be configured to build an information handling system 102 by adding and/or configuring various components of the information handling system.

As shown in FIG. 3, factory build server 302 may extract a BIOS 106 to be verified and stored on an information handling system 102. Once BIOS 106 is extracted, factory build server 302 may generate a BIOS image map file 308 in a manner similar to that of BIOS build server 202, such that BIOS image map file 308 sets forth store range descriptors which record the physical memory address ranges of BIOS code (e.g., the various individual portions of BIOS code 204) and includes hashes of the BIOS code stored in each of the physical memory ranges of the BIOS code of extracted BIOS 106. In addition, factory build server 302 may download or otherwise acquire (e.g., from a website of the developer of BIOS 106) BIOS image map 208 generated by BIOS build server 202. Factory build server 302 may then compare BIOS image map 208 to BIOS image map 308. If BIOS image map 208 and BIOS image map 308 are identical, then factory build server 302 may generate an indication that BIOS 106 is unaltered from the time it was stored as a signed BIOS 106 by BIOS build server 202. On the other hand, if BIOS image map 208 and BIOS image map 308 do not match, then factory build server 302 may generate an indication that BIOS 106 has been altered from the time it was stored as a signed BIOS 106 by BIOS build server 202.

Using the systems and methods described herein, supply chain assurances for a BIOS, or other code, may be gained. Advantageously, such approach may also be scalable as BIOS and platform specific differences may be encompassed into a BIOS image map and the BIOS release process.

In addition, although the discussion above contemplates BIOS verification during factory build, similar or identical processes may be used to verify a BIOS at other stages of an information handling system lifecycle. For example, in some embodiments, a BIOS image map 208 could be released to an end user customer who may apply it to verify a BIOS installed on such customer's information handling system.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor; and
a program of instructions embodied in a computer-readable medium, the instructions configured to, when read and executed by the processor:
store in an image map file one or more range descriptors recording one or more physical memory address ranges storing code to be installed to a second information handling system; and
store in the image map file one or more hashes, each hash associated with code stored in a respective one of the one or more physical memory address ranges.

2. The information handling system of claim 1, wherein the code is basic input/output system code.

3. An information handling system comprising:
a processor; and
a program of instructions embodied in a computer-readable medium, the instructions configured to, when read and executed by the processor:
store in a first image map file one or more range descriptors recording one or more physical memory address ranges of a first memory storing code;
store in the first image map file one or more hashes, each hash associated with code stored in a respective one of the one or more physical memory address ranges of the first memory;
receive a second image map file, the second image map file created by:
storing in the second image map file one or more range descriptors recording one or more physical memory address ranges of a second memory storing code; and
storing in the second image map file one or more hashes, each hash associated with code stored in a respective one of the one or more physical memory address ranges of the second memory; and
compare the first image map file to the second image map file.

4. The information handling system of claim 3, wherein the code is basic input/output system code.

5. The information handling system of claim 3, the program of instructions further configured to generate an indication that the code stored in the first memory matches the code stored in the second memory in response to determining that the first image map file matches the second image map file.

6. The information handling system of claim 3, the program of instructions further configured to generate an indication that the code stored in the first memory does not match the code stored in the second memory in response to determining that the first image map file does not match the second image map file.

7. A method comprising:
storing in an image map file one or more range descriptors recording one or more physical memory address ranges storing code to be installed to a second information handling system; and
storing in the image map file one or more hashes, each hash associated with code stored in a respective one of the one or more physical memory address ranges.

8. The method of claim 7, wherein the code is basic input/output system code.

9. A method comprising:
storing in a first image map file one or more range descriptors recording one or more physical memory address ranges of a first memory storing code;
storing in the first image map file one or more hashes, each hash associated with code stored in a respective one of the one or more physical memory address ranges of the first memory;
receiving a second image map file, the second image map file created by:
storing in the second image map file one or more range descriptors recording one or more physical memory address ranges of a second memory storing code; and
storing in the second image map file one or more hashes, each hash associated with code stored in a respective one of the one or more physical memory address ranges of the second memory; and
comparing the first image map file to the second image map file.

10. The method of claim 9, wherein the code is basic input/output system code.

11. The method of claim 9, further comprising generating an indication that the code stored in the first memory matches the code stored in the second memory in response to determining that the first image map file matches the second image map file.

12. The method of claim 9, further comprising generating an indication that the code stored in the first memory does not match the code stored in the second memory in response to determining that the first image map file does not match the second image map file.
